(19) United States
(12) Patent Application Publication
(10) Pub. No.: US 2026/0103218 A1
(43) Pub. Date: Apr. 16, 2026

(54) XYZ MOTION PLANNING FOR VEHICLES

(71) Applicant: CLEARMOTION, INC., Billerica, MA (US)

(72) Inventors: Yu Jiang, Wellesley, MA (US); Sayan Chakraborty, Brooklyn, NY (US); Marco Giovanardi, Melrose, MA (US); William Graves, Somerville, MA (US)

(73) Assignee: CLEARMOTION, INC., Billerica, MA (US)

(21) Appl. No.: 19/114,669

(22) PCT Filed: Sep. 28, 2023
(86) PCT No.: PCT/US2023/075311

§ 371 Date: Mar. 24, 2025

Related U.S. Application Data
(60) Provisional application No. 63/410,815, filed on Sep. 28, 2022.

(51) Int. Cl. B60W 60/00

(52) U.S. Cl. CPC B60W 60/0011; B60W 60/0013; B60W 60/0015; B60W 60/0023; B60W 2552/35

(57) ABSTRACT

Methods and systems are presented for planning and commanding motions of a vehicle in the plane of a road and in the vertical direction, relative to the plane of a road, to enhance vehicle performance, as it may relate to, for example, vehicle safety, occupant comfort, wear and tear on the vehicle, and/or vehicle efficiency. One or more processors may be used to plan XYZ vehicle trajectories and to provide commands to systems such as, for example, active suspension systems, semi-active suspension systems, propulsion systems, braking systems (e.g. ABS), and/or steering systems. The one or more processors may also receive road information from, for example, look-ahead sensors (e.g. LiDAR), local or remote databases, and motion sensors (e.g. IMUs, accelerometers). The one or more processors may also exchange information with a driver and/or other vehicle occupants, various on-board or remote databases, and/or infrastructure systems (e.g. GPS) by means of one or more communication devices.

### RELATED APPLICATIONS

This application claims the benefit of priority under 35 U.S.C. § 119(e) of U.S. application Ser. No. 63/410,815, filed Sep. 28, 2022, the disclosure of which is incorporated herein by reference in its entirety.

### FIELD

Disclosed embodiments are related to the control of the motion of a vehicle as it travels along a road.

### BACKGROUND

Autonomous vehicles, such as robots and autonomous automobiles, currently in use, typically employ route planning algorithms to navigate factory floors or open roads. These algorithms select a route to a destination that avoids collisions with other vehicles or obstacles. The route planning process typically involves the analysis of real-time data concerning the vehicle's environment collected by one or more sensors.

### SUMMARY

In some aspects, the techniques described herein relate to operating a vehicle including: traveling along a road; receiving information about a segment of the road ahead of the vehicle, where the information includes data about the surface of the road ahead of the vehicle's current position (such as, for example information about potholes, speed bumps, manhole covers, road surface cracks, and frost heaves); using an algorithm to develop a multiplicity of feasible motion plans for moving forward from the current position of the vehicle based on the received information; developing at least one trajectory for each of the multiplicity of feasible motion plans (which may exclude trajectories that may result in collisions with other vehicles, pedestrians, and obstacles), wherein at least one of the trajectories accounts for out of plane motions induced by the road surface; projecting a cost of traveling along each of the at least one trajectory for each of the multiplicity of feasible motion plans; selecting trajectory based at least partially on cost; providing the selected trajectory to a vehicle operator (which may be for example a person or an electronic vehicle controller); and operating the vehicle by implementing the selected trajectory. At least a portion of the received data may be received from a database (remote or on-board the vehicle) that includes previously collected information about the road such as may be obtained by crowd sourcing or from one or more look-ahead sensors on-board the vehicle. The vehicle may be a fully autonomous vehicle, a semi-autonomous vehicle, or a manually driven vehicle. The cost may be based on, for example, energy consumption; travel time, occupant comfort, violation of traffic regulations, the wear and tear of components, safety and/or environmental impact.

In some aspects, the techniques described herein relate to operating a vehicle including: traveling along a road; receiving information about a segment of the road ahead of the vehicle's current position, where the information includes data about road surface characteristics (such as, for example information about potholes, speed bumps, manhole covers, road surface cracks, and frost heaves) that may induce out of plane motions; selecting, based on the received information, a trajectory with a short duration (e.g. less than 30 seconds, less than one minute and less than two minutes), where the trajectory includes both XY motions and Z motions; providing the trajectory to a vehicle operator (e.g. a person or one or more microprocessors) and operating the vehicle by implementing the trajectory.

In some aspects, the techniques described herein relate to operating a vehicle including: traveling along a road; receiving information about a lateral distribution of an anticipated intensity of an adverse effect, on the vehicle, at a series of discrete longitudinal positions along the road; receiving at least one constraint limiting an operation of the vehicle (e.g. prohibition from leaving the lane of travel, offset from the centerline of the lane of travel, and/or maximum lateral acceleration); calculating a cost function based on the intensity and the at least one constraint; and traversing each of the longitudinal positions at a point determined based on the cost function.

It should be appreciated that the foregoing concepts, and additional concepts discussed below, may be arranged in any suitable combination, as the present disclosure is not limited in this respect. Furthermore, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic illustration of an embodiment of a vehicle; including a vehicle control system and vehicle sensors;

FIG. 2 illustrates a map of intensity of a parameter associated with a road surface as a function of lateral position and longitudinal position along a roadway;

FIG. 3 illustrates an example of an optimal path plan along the roadway of FIG. 2;

FIG. 4 illustrates two-dimensional representation of the intensity mapping of FIG. 2;

FIG. 5 illustrates an implementation of a sample-based method to plan the XYZ motion of a vehicle;

FIG. 6 illustrates an example of certain safety benefits of XYZ motion planning;

FIG. 7 illustrates a block diagram of an implementation of an exemplary architecture of an XYZ motion planner;

FIG. 8 illustrates a block diagram of a flowchart of an exemplary XYZ motion planner;

FIG. 9 illustrates an example of the comfort benefits with XYZ motion planning.

FIG. 10 is a flow chart of another embodiment of a method for operating a vehicle.

FIG. 11 is a flow chart of yet another embodiment of a method for operating a vehicle.

### DETAILED DESCRIPTION

In current autonomous vehicles traveling along a roadway, planning algorithms may plan a trajectory for traversing an upcoming road segment. The plan may then be implemented by a controller commanding one or more actuators in the vehicle. These trajectory planners primarily focus on selecting the optimal trajectory within the plane of the road surface, commonly referred to as XY plans. The selection of an optimal XY plan typically relies on various factors, including road geometry and lane markings, the positions and speeds of other vehicles, the presence of fixed or soft obstacles, and the locations of pedestrians. As used herein, the term “plane of the road surface,” refers to a plane, that is not necessarily horizontal, but that parallels the nominal surface of a road. This plane does not include road surface imperfections or the anomalies of the actual road such as, for example, potholes, manhole covers, speed bumps, surface cracks, or frost heaves.

The inventors have recognized the advantages of considering out-of-plane motions, referred herein alternatively as Z motions. Z motions may be induced within a vehicle or a portion of a vehicle (e.g., a wheel, wheel assembly, passenger compartment, vehicle body, or vehicle chassis) when one or more vehicle wheels interact with road surface irregularities or discontinuities (e.g., potholes, bumps, manhole covers, cracks, uneven or missing pavement, or extraordinary road surfaces such, for example, as gravel). As used herein, the term “out-of-plane motion” refers to motion of a vehicle or a portion of a vehicle in a direction that is perpendicular to the plane of the road surface in close proximity to the vehicle or the portion of the vehicle.

Furthermore, the inventors recognized that a more comprehensive motion plan, which takes into account both potential Z motions, outside the plane of the road, and XY motions, within the road plane, may result in an optimal vehicle trajectory. Conversely, planning algorithms that do not adequately consider Z motions may travel along trajectories that may result in increased discomfort, increased vehicle wear and tear, safety hazards, and/or other negative effects. Additionally, the inventors have recognized that Z motions may be influenced by other aspects of a vehicle or the state of a vehicle, e.g. speed, mass, and center of gravity location, as well as the characteristics and capabilities of various onboard systems (e.g., active, semi-active, or passive suspension systems, propulsion systems, braking systems, steering systems, and sensor systems).

Therefore, planning algorithms that consider both Z motions as well as XY motions, i.e. motions in the plane of the road surface, hereinafter referred to as XYZ planners, may consider, under at least some operating conditions, road surface features that may cause out-of-plane motions, the state of the vehicle, and/or the characteristics or capabilities of one or more systems on board the vehicle, when planning the optimal vehicle trajectory.

For example, the optimal XYZ trajectory for a vehicle with an active suspension system, travelling at a first speed, may be quite different from an optimal XYZ trajectory for a vehicle that has a semi-active suspension or passive suspension travelling at the same or a different speed. Alternatively or additionally, the optimal trajectory for a vehicle may depend on other vehicle state parameters such as, for example, the degree of wear of one or more actuators or degree of inflation of one or more tires. Alternatively or additionally, the inventors have recognized that providing optimal trajectory information to a driver or operator of a non-autonomous or semi-autonomous vehicle, by for example using various communication channels, e.g. ADAS, may also be beneficial. As used herein, the term “vehicle operator” or “operator” refers to a human driver and/or to a computing device that manages aspects of the operation of a vehicle by using one or more actuators on-board the vehicle. As used herein, the term “semi-autonomous vehicle” refers to a vehicle equipped with a controller capable of performing certain tasks, such as, for example braking, accelerating, steering, and lane changing, while allowing human intervention as needed. It is important to note that in a semi-autonomous vehicle, the controller may be either a human operator or a computing device, with the human operator capable of assuming control as needed.

In some embodiments of a vehicle, one or more motion planning algorithms, operating on one or more microprocessors, may simultaneously determine an optimal XY plan and Z trajectory, resulting in an optimal XYZ trajectory. Alternatively, in some embodiments of a vehicle, one or more motion planning algorithms may determine an optimal XYZ trajectory in a multi-step process. For example, an XYZ planner may first determine multiple feasible motion plans, that are candidate XY plans (e.g. greater than one but less than 10 XY plans, more than 3 but less than 100 plans), and then determine the optimal XYZ trajectory by comparing the cost of Z trajectories associated with the candidate XY plans. The appropriate number candidate XY plans that may be selected by a motion planning algorithm may be outside the ranges specified above as the disclosure is not limited to the specified ranges. The number of candidate XY plans may be predetermined or determined during the planning process based on, for example, characteristics of the road and/or the state of the vehicle. As used herein, the term “feasible motion plan” refers to a motion plan that abides by various, although not necessarily all, relevant constraints. A feasible motion plan may be a physically achievable plan that does not violate the operational limits of the vehicle.

Additionally or alternatively, other factors that may be considered, in either the first or subsequent steps of selecting the optimal XYZ trajectory, may include but are not limited to: the local coefficient of friction of the road surface, the anticipated amount of energy that may be consumed by one or more on-board systems, e.g. a suspension system, a propulsion system, along the various candidate XYZ trajectories and/or the amount of available energy, such as on-board fuel or stored electrical charge.

In order to control X motion (i.e. motion in the plane of the road surface (or in a plane parallel to it) and aligned with the direction of travel), a control mechanism or actuator for the accelerator and/or brake of the vehicle may be present, or a method for alerting a human operator to a desired change in speed. In order to control the Y motion (i.e. motion in the plane of the road surface (or in a plane parallel to it) and normal to the direction of travel), a steering mechanism may be present, or a way to alert a human operator to the desired path to take. In order to control Z motion (i.e. motion normal to the plane of the road surface), an actuation system may be present in the suspension of the vehicle. A plan may be made for an optimal motion path, and action can be taken if a actuators for implementing such actions are available.

In some embodiments, a plan for the motion may be configured to minimize, for example, vehicle occupant discomfort, e.g. motion sickness or excessive exposure to vibration. This method may include mapping areas on a roadway that may include road surface characteristics that may induce occupant discomfort, and using information, which e.g. may be in the form of a map, about certain details and/or location of those characteristics, to calculate a path that minimizes or mitigates the expected occupant discomfort, while respecting certain constraints and taking into account factors that affect safety and comfort of one or more vehicle occupants related to in-plane motions and motions caused by in-plane movements. As used herein, the term “in-plane motion” refers to motion of a vehicle or a portion of a vehicle in the plane of the road surface.

In some embodiments, a first step to implementing this method may include generating a map. Aspects of a road or road events that may cause occupant discomfort along a roadway may be, for typical road types in use today, highly bi-modal in nature. Bi-modal roads may have smooth or effectively smooth sections followed by sections that include cracks, potholes and/or other anomalies or discontinuities. Inventors have recognized that the complexity of vehicle trajectory calculations may be simplified by taking advantage of the bimodal nature of certain roads. This may be achieved by initially identifying aspects of a road that may result in road events that may cause certain effects above a pre-determined threshold of those effects. This threshold may be set at an appropriate level as it may used to reduce the complexity of the solution, and thus may be set to a lower (or more sensitive) value when more complexity may be tolerated, e.g. when sufficient processing capacity is available, and a higher (or less sensitive) value when there may be a desire to reduce complexity and/or computational burden. In one embodiment, one or more vehicles driving on a bi-modal roadway may record the position on the road surface of any aspect that may be projected to cause an event that exceeds a threshold value of an effect. A discomfort may be qualified by assessing its estimated effect on one or more occupants, for example by collecting sensor data, and/or calculating a metric related to the effect on the occupant. Sensors may include, for example: accelerometers positioned near an occupant (e.g. on a chair rail), on the vehicle body, or on suspension components, on the wheel or knuckle; ride height measured between the wheel and the body; road contour measured by a non-contact sensor such as a laser, LiDAR, radar, or camera; rate sensors on the vehicle or a component; wheel speed sensors; and others. Metrics may include estimating energy, peak thresholds, peak-peak excursions, or calculating derivatives or integrals of the measured signals and then applying metric calculations. Metrics may also include other calculations that may take into account occupant sensitivity to particular frequencies, time histories, and/or metrics that may include combining various signals to calculate a synthesized signal and applying metric calculations to that signal. By way of example, one or more vehicle body acceleration sensors may be combined into estimating the acceleration of the vehicle body above a wheel patch, and a ride height sensor may be combined with this signal to calculate wheel motion; the resulting wheel motion may be trimmed into a short window and the total energy of the signal in that window may be used to estimate the relative effect on an occupant. As used herein, the term “road event” refers to the interaction or the potential interaction of a vehicle or a portion of the vehicle, e.g. a wheel of the vehicle, with a road surface imperfection or anomaly such as, for example, potholes, manhole covers, speed bumps, surface cracks, or frost heaves. As used herein, a “bi-modal road surface” refers to a road that has one or more portions of smooth road surface, without perceptible imperfections and anomalies and also one or more portions that have perceptible road surface imperfections or anomalies such as, for example, potholes, manhole covers, speed bumps, surface cracks.

In some embodiments, the intensity of road events recorded on a map may be determined. As used herein, the term “intensity” refers to a measure of an effect, such as, for example, an adverse effect, a discomfort, or other objectionable effect, on a vehicle and/or vehicle occupant and/or vehicle component as a result of a road event. The intensity may be a single output or a combination of multiple outputs, such as for example the peak value between multiple metrics associated with an event. Intensity may, for example, be the value of the wheel energy calculated as described above, or it may be any other appropriate signal derived from sensors and metric computations.

A given distribution of intensity may be associated with a location on the map. The location may be determined through any absolute or relative location measurement systems. Absolute measurements may include Global Navigation Systems (GNS) or similar devices, while relative measurements may be relative to the roadway, such as by using dead reckoning, road contour mapping or visual mapping of road features on the road surface such as lane markings, or relative to objects along the road or positioned near the road, for example using non-contact sensors such as LiDAR, radar, or visual sensors such as cameras to detect and recognize objects and estimate a distance of the vehicle from those objects. In some embodiments, a location along the road may be determined relative to a road contour, and a location across the width of the roadway may be determined relative to one or more lane markings.

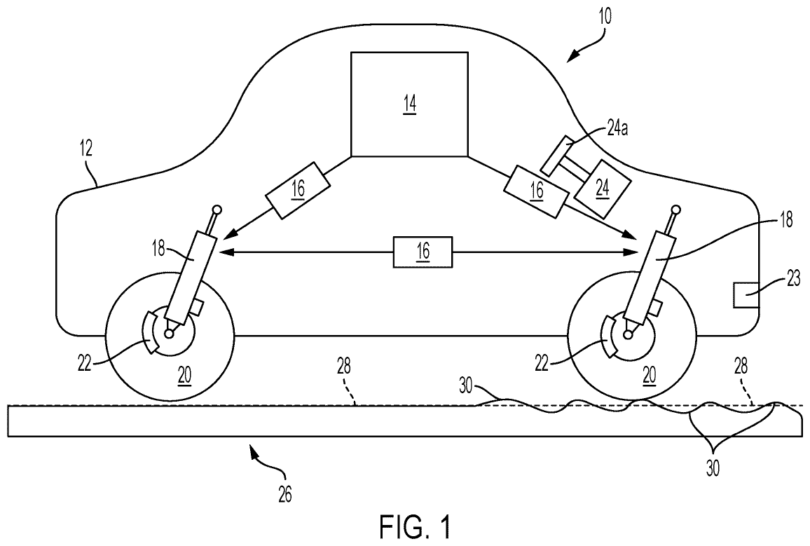

FIG. 1. illustrates a vehicle 10. The vehicle includes a vehicle body 12 that supports the various components of the vehicle. As shown in FIG. 1, the vehicle includes a microprocessor system 14, with one or more microprocessors, which may communicate with various subsystems via a communication channel 16. It is noted that in FIG. 1, although the microprocessor system 14 is shown as a single unit, it may include multiple microprocessors located in multiple locations in the vehicle, as the present disclosure is not limited in this respect. As shown in FIG. 1, the vehicle may include an active suspension system, with active suspension actuators 18, that is operatively interposed between the wheels 20 (or the wheel assembly, of an unsprung mass) of the vehicle and the vehicle body 12 (e.g., sprung mass). In particular, active suspension actuators 18 may be operatively interposed between each wheel of the vehicle and the vehicle body 12, such that separate actuators of the active suspension may independently control the vertical motion of individual wheels of the vehicle. Each actuator 18 may be configured to apply force between the wheels 20 and the vehicle body 12. The actuators 18 may affect a motion response of the body 12, and in particular one or more vehicle motion characteristics. The vehicle may also include a braking system with brakes 22. The braking system may include independent brakes coupled to each of the vehicle wheels 20, such that a braking force may be applied to each wheel independently. According to the embodiment of FIG. 1, the vehicle may also include a forward-looking sensor 23. The forward-looking sensor may be, for example, one or more cameras, LIDAR, radar, a combination thereof, or other sensor that may be configured to sense forward-looking road information that may be employed by one or more vehicle planners or controllers which may be located in the microprocessor system 14. Alternatively or additionally, previously collected forward-looking road information may be received, at one or more microprocessors in microprocessor system 14, from one or more local or remote databases.

According to the embodiment of FIG. 1, the vehicle may also include a steering system 24 including, in the case of a driven vehicle, a steering wheel 24a. The steering wheel 24a may form a part of a user interface of vehicle 10. The user interface may be used to provide user input to control various portions of the vehicle or to provide feedback, e.g. tactile feedback, to a user. In some embodiments, the steering system 24 may include a rear steering system configured to control one or more rear wheels of the vehicle. Other user interfaces may also be used as the present disclosure is not limited in this respect.

As shown in FIG. 1, the vehicle may traverse over road 26. As illustrated in FIG. 1, the road may include a plane of the road surface 28, i.e. the nominal road surface, as well as road features 30. The road features 30 may induce motions or fluctuations that are normal to the plane of the road surface 28.

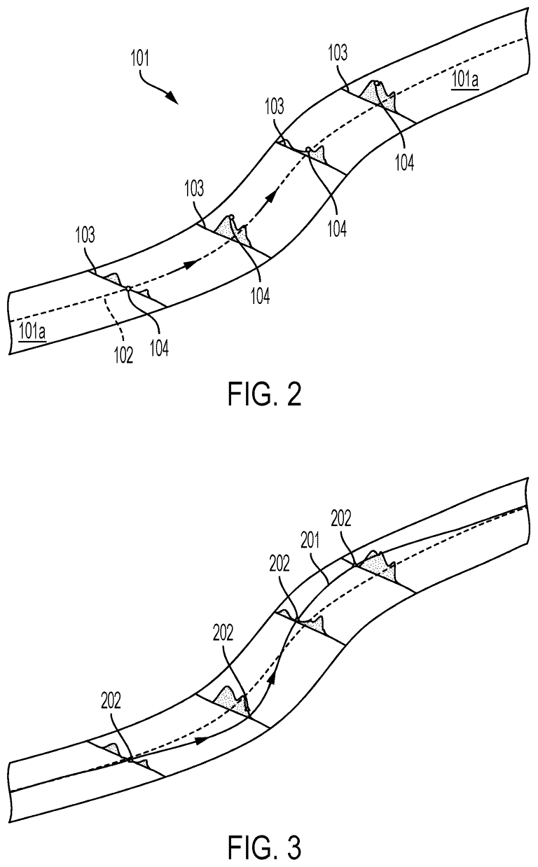

FIG. 2 illustrates an exemplary intensity map that may be obtained in the manner described above. On roadway 101, which may include a centerline path 102 that curves in the XY plane that maps to the plane of the road surface 101a (and thus follows road vertical contour if the road changes elevation, for example). In this embodiment at discrete locations 103 there may be events that may cause the vehicle to experience an intensity above a threshold. After multiple previous drives by one vehicle or more vehicles, which traverse the events 103 at different lateral offsets, an intensity map may be generated, as illustrated in FIG. 2 The map may contain detailed data for intensity at individual longitudinal locations 103 that may be obtained and recorded as a function of lateral position. If a vehicle were to drive on the roadway in FIG. 2 and remain on the centerline, it may encounter the events at the intensities marked at points 104. A map can thus be created, based, for example, on crowd-sourced data collected from one or more vehicles. Alternatively or additionally, the intensity profile maps may be generated based on data from one of more dedicated test vehicles; and/or from images of the roadway and using visual recognition of map significant road events. For example, such images may be obtained from a street-view source or from satellites, if available in high enough resolution, or they may be collected by a dedicated fleet or through crowdsourcing from one or more vehicles. The map may also be obtained, as an input, from a map provider or a municipality or other entity.

Given this map, an optimized trajectory may be determined for the vehicle to take such that the intensity the vehicle encounters are included in a cost function along with other metrics, where certain constraints may also be enforced. An example of a constraint that may be imposed may be, for example, that when traveling along the optimal path, the vehicle may not leave the lane at any given point. Such a constraint may be enforced if, for example, a width of the lane at any given point were known or measured (or by assuming a standard minimum lane width where data is not available), and if a width of the vehicle were known (or assumed based on typical vehicle widths). Then the maximum permitted offset from the centerline may be determined and the vehicle may be prevented from violating this constraint. An example of another metric may be the total amount of deviation off the centerline in a given amount of time, as this may disturb one or more occupants that may be, for example, prone to motion sickness. Therefore, in some embodiments under certain operating conditions, the maximum lateral acceleration induced by the vehicle when following the prescribed trajectory may be a constraint. A combination of the desired metrics may be formulated into a cost function, with relative weights, applied to the various metrics, which may be pre-calculated or may be dynamically adjusted based on the driving situation. In this manner thus an optimal trajectory may be determined that minimizes a given cost function. An example of such a path is shown in FIG. 3 as line 201. It should be noted that the optimization problem formulated here includes a cost associated with events on the road as described above. If the vehicle follows path 201 instead of path 102, it may experience lower intensity from road events and thus the occupants may be more comfortable.

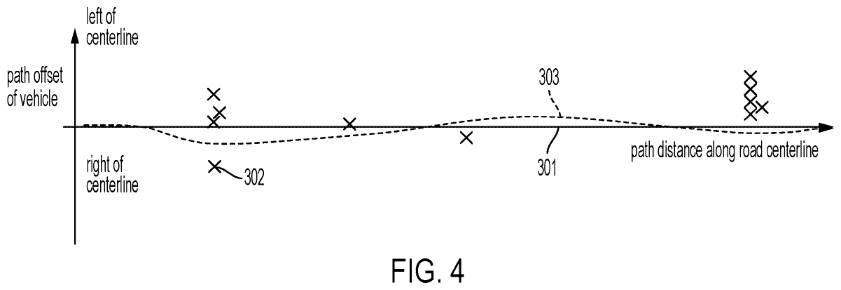

FIG. 4 illustrates an exemplary intensity map illustrated in the relative or absolute space along the roadway in the longitudinal direction and across the roadway in the lateral direction. The road in this coordinate system may be shown as straight road since the abscissa in this plot follows the centerline of the road, and the ordinate is normal to the road centerline. In this view, path 301 along the centerline of the road follows the abscissa, and events are marked as intensity values such as 302 with a location along the roadway and a lateral offset across the roadway for each measurement, as well as an intensity value associated with each point that is not shown in this representation. These values may be determined over time if they are collected using crowd sourced data from one or more vehicles or may be a given input from an existing map. Given these values and the path, the optimization problem can be reduced to a problem of calculating the optimal lateral offset at each given point, while optimizing the cost function described above and remaining within the constraints also described above. The resulting optimal path may have a shape similar to 303 but may depend on the formulation of the cost function and the relative intensity values measured at each point.

In some embodiments, road intensity may be measured based on vehicle-based motion sensors as described above; in which case the measurements may be normalized to avoid a mismatch in the estimated values. This can be done on each vehicle by comparing the estimated values from the ego vehicle with those from a set of other vehicles. It can also be achieved by considering each intensity value as a relative value with respect to other events collected by the same vehicle. Additionally or alternatively, it may also be achieved through the appropriate calibration of the sensors and processing to remove any bias introduced by an individual vehicles. Road intensity may also be measured by non-contact or normalized sensors.

The influence of speed on intensity may be considered, as the impact of a given road event on a given vehicle may be different at different speeds. While the intensity resulting from road events may increase with speed, this may not always be the case. For example, in the case of an event that is a pothole of a certain size, above a certain speed a vehicle may be exposed to less and less input from the pothole the higher the speed of the vehicle. This may be because the wheel interacting with the pothole may have less and less time to penetrate into the pothole.

Any given event may result in an intensity that varies with the speed of the vehicle. Information about this variation of intensity as a function of speed, which may be associated with various events recorded in a map, may be considered, along with the current or planned driving speed, when calculating an optimal trajectory. For example, the vehicle speed may be projected to be relatively constant as a vehicle follows a given trajectory, and the optimal trajectory may be determined using intensity values acquired at the projected speed for various events on a given trajectory. In some embodiments, a speed map of intensity may be generated for each event, which would allow the expected intensity at the projected speed to be determined by interpolation or extrapolation. Using such a speed map, and the current driving speed, the optimal trajectory at any given speed may be determined. In some embodiments, it may also be possible to consider speed as a variable and to determine the optimal profile and optimal speed. To solve this problem, deviation from a target speed, or a total time of traversal, may be considered in the cost function. In some embodiments, constraints related to, for example, the maximum allowable change in speed may also be considered to reduce the effect of any speed changes on vehicle occupants. In some embodiments, this method may be used to optimize, for example, the traversal of a large speedbump, where lateral deviation may not be effective in reducing the intensity of the event but a reduction in speed in the vicinity of the speed bump may be effective in increasing occupant comfort.

Selecting the optimal trajectory may include the minimizing or maximizing other properties or quantities, as the present disclosure is not limited in this respect. For example, in addition to, or instead of, occupant comfort, a desired target may be minimum travel time, reduced likelihood of motion sickness, or reduced expected damage to or wear and tear on the vehicle or its components, or any other value that may be affected by the choice of vehicle trajectory (including speed) along a roadway. Undesirable results may also include the vehicle getting too close to the edge of any lane or certain markings. Costs associated with, for example, distance from the edge of a lane may be included; proximity to another vehicle, which may require an adaptation of the plan if the operator (computing hardware or human) detects such a vehicle. In the case of a driven vehicle, a human driver may respond by counteracting the planned vehicle trajectory through imparted steering torque. In some embodiments, such user input may cause the trajectory planner to re-calculate the optimal solution. Other undesirable effects that may be included in the cost function may include: a perceptible “wandering” of the vehicle, defined as vehicle yaw or lateral motion in a specific frequency band or time that the occupant is sensitive to; total steering angle, rate, or torque; lateral acceleration due to the trajectory along the optimal path; specific expected vehicle motions such as rolling of the vehicle that the occupant or the vehicle may be more sensitive to; and estimated component damage caused by high intensity inputs. One or more of these factors may be considered at any given time, with relative weighting that may be dynamically altered, prescribed by the user via a user interface or the driving situation, or pre-calculated by the developer or OEM for consistency, or calculated by a microprocessor at any specific instance.

In some embodiments, one or more road surface characteristics may be considered during XYZ trajectory or XY path optimization. A road surface characteristic may for example be a predicted or detected road surface grip or road friction. A predicted road surface grip may, for example, be derived from a crowd-sourced system that may map measured road friction characteristics to locations and time, whereupon a prediction algorithm may be used to extend the measurement in both time and location to cover the current location of the vehicle is consuming the data. A road surface characteristic may also be derived from previous measurements and/or weather measurements taken at strategic or distributed locations or may be simply derived from weather forecasts. If an expected road surface characteristic is known for at least one desired path in the plan, then a decision may be made to include this knowledge in the cost function calculation for the path planner.

For example, a vehicle travelling along a road may have access to a road friction prediction from a remote road friction prediction system. As the planning algorithm in the vehicle determines candidate XY paths, it may consider information about the road surface of each path. For example, the coefficient of friction or projected tire grip of each candidate path may be considered in determining the cost to the associated trajectory. Additionally or alternatively, in some embodiments road surface profile, the geometry of the road, the required power, effort, or strain on one or more system or components; and the safety of each path or trajectory may be considered in determining the cost of each path or trajectory. In some embodiments, the safety margin and how close each path or trajectory is likely to get to that margin, such as for example proximity to other vehicles, proximity to expected vehicle limits in lateral or longitudinal grip, or proximity to objects on or near the road. For each plan or trajectory, a required steering, accelerator/brake, and vertical component of input may be calculated, where those inputs are available to the human operator or an autonomous controller, or a desired action may be provided as a guidance to the human driver or operator. This effort may be taken into account when estimating the optimal path, as it may involve a cost in terms of comfort, safety, power, noise, or other factors that may weigh on the decision. For example, if an active suspension system is available, then an expected low friction surface may be mitigated with a change in vertical force application at an appropriate time, and this application of force may be considered when calculating the optimal path or trajectory.

An optimal path or trajectory may then be selected based on one or more of the factors described above, and action taken accordingly to provide guidance or input to a vehicle controller or the vehicle operator.

In some embodiments XYZ planning may be used to compute an optimal trajectory in X, Y, and Z direction to improve vehicle performance, including safety and comfort. Without wishing to be bound by theory, in some embodiments, an exemplary XYZ motion planning problem may be formulated as the following optimization problem:

$${min}_{s , u , T} J ( s , u , T , r )$$

$$subject to \dot{s} = {f}_{r} ( s , u , r )$$

$$s ( 0 ) = {s}_{0}$$

$$( s , u ) ∈ X ( t ) , ∀ t ∈ [ 0 , T ]$$

In the above optimization problem formulation, s(t) is a vector of vehicle states, including but not limited to vehicle speed, steering angle, location, heading, suspension height, suspension velocity; u(t) is a vector of the control inputs to the vehicle, including steering control input, speed control input, active forces applied on each suspension; the differential equation \dot{s}=fᵣ(s, u) describes the vehicle dynamics, which can be represented by a 14-degree of freedom model, a bicycle model with multiple quarter car models, or other models. r is the road surface, defined as a function of different locations in the road plane. The time horizon for the motion plan may be from 0 to T, and the terminal time T may also be a variable to optimize. The plan can be sequences of data sampled at discrete time points. At t=0, the state of the plan starts at the current state condition so of the vehicle. On the entire horizon, the vehicle state s(t) and the control input u(t) may satisfy certain constraints. For example, there may be a limit of 10 cm physical constrain on how much the suspension may travel up or down. There may also be a force constraint on the maximum level of active force the suspension system may provide. In this optimization, there may also be other constraints, such as the maximum steering angle, the maximum allowed longitudinal and lateral accelerations. The cost function may be defined as J(s, u, T, r). This cost is a combination of different costs from X, Y, and Z directions. For example, the cost function may take the form of

$$J ( s , u , T , r ) = {\int }_{0}^{T} [ {{w}_{v} ( v - {v}_{0} )}^{2} + {{w}_{y} ( y - {y}_{0} )}^{2} + {w}_{z} {\vert \dot{z} \vert}^{2} + {w}_{f} {\vert f \vert}^{2} ] dt + {w}_{T} T$$

in which v₀ is the nominal speed that the vehicle maintains, y₀ is nominal lateral displacement of the vehicle, z the averaged vertical velocity of the vehicle, and f the total force command applied onto the suspension. The variables wᵥ, w_{y}, w_{z}, w_{f}, and WT are weights to be designed or tuned. It should be noted that cost function may be expressed in many forms, if it is expressed as a function of the vehicle state, the control input, and the time horizon.

It should be noted that in some embodiments, a path in the XY plane may be made up of a sequence of discrete way points [(x₁, y₁), (x₂, y₂), the (x_{N}, y_{N})] with N a positive integer, or a pair of continuous functions [x(s), y(s)] where s≥0 is the longitudinal distance of the road. A trajectory is a sequency of a higher dimension vector. In the continuous form, the trajectory may be a vector function of time and may be defined as

$$[ x ( t ) , y ( t ) , h ( t ) , v ( t ) , {z}_{i} ( t ) , {\dot{z}}_{i} ( t ) , a ( t ) , {f}_{i} ( t ) , {r}_{i} ( t ) ]$$

where t≥0 is the time, and h the vehicle heading, v the vehicle velocity, zᵢ the vertical displacement of the i-th corner of a car with respect to the road plane, żᵢ(t) the vertical body velocity at the i-th corner, and fᵢ(t) the active suspension control force at the i-th corner, rᵢ(t) the height of the road at the i-th wheel. More elements can be added to the trajectory vector, based on the model being studied.

As a nonlinear optimization problem, the in-vehicle XYZ motion planning may not be effectively implemented by commercially available generic nonlinear optimizers for several reasons: First, the XYZ motion planning problem involves considering the complex dynamics of the vehicle, including acceleration, deceleration, turning, suspensions, and other physical constraints. Without wishing to be bound by theory, these dynamics result in a high degree of nonlinearity and non-convexity, and therefore generic optimizers may struggle to efficiently handle such complexity. Second, with the added Z-motion, the motion planning problem operates in a high-dimensional state space which may include the vehicle's position, velocity, orientation, suspension state, and road surface information. Optimizing in high-dimensional spaces may be challenging, and it becomes increasingly difficult as the dimensionality grows. Third, motion planning for vehicles often needs to be performed in real-time or near-real-time to ensure the vehicle's safety and responsiveness. For example, in some embodiments, the motion planner may calculate a plan in every 0.1 seconds. Generic optimizers may not be able to provide solutions within the required time frames, especially when dealing with complex, high-dimensional problems. Fourth, vehicles must adhere to various constraints, such as collision avoidance, road boundaries, vehicle limitations (e.g., turning radius, maximum speed, maximum suspension travel, maximum active suspension force command). Incorporating these constraints into the optimization problem makes it even more complex and difficult for generic optimizers to handle. Fifth, safety may be paramount in vehicle motion planning, generic optimizers may not provide sufficient certainty of safety, and it is crucial to have methods capable of accounting for safety constraints and provide provably safe solutions. Sixth, motion planning problems often need to be solved in real-time on resource-constrained hardware, such as onboard vehicle computers. Without wishing to be bound by theory, it is believed that generic nonlinear optimizers may be too computationally intensive to run efficiently in such environments.

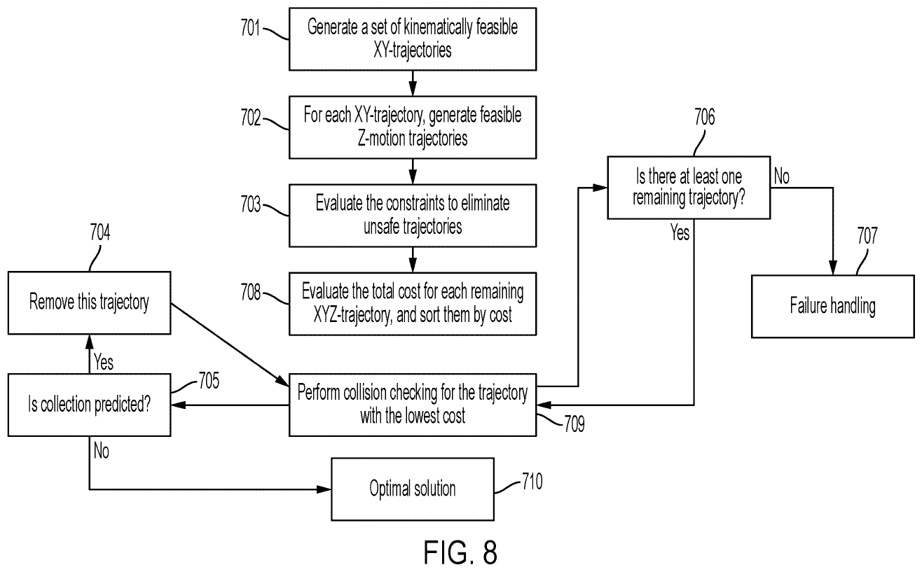

FIG. 8 illustrates an exemplary sample based XYZ motion planning method that may be used to address these challenges. First, block 701 may select a set of XY candidate path plans or trajectories, in which the Z-motion out-of-plain motion is not considered. Again, without wishing to be bound by theory, this may be achieved by using fourth or fifth order polynomials to connect the current position of the vehicle to a few possible final positions on the road. It should be noted that for the same final position, different XY-trajectories or path plans may be generated by, for example, considering different speed profiles. For example, for each final position, three different final speeds may be projected which may result in at least three different speed profiles during the traverse of the trajectories. For each of the XY-trajectories created at 701, at block 702 multiple Z trajectories may be obtained to produce multiple XYZ-trajectories. In some embodiments, at block 703, all the XYZ-trajectories may be tested against a set of safety criteria, such as, for example, maximum lateral accelerations or suspension actuator forces or suspension travel. Certain XYZ trajectories may then be eliminated at block 703. The remaining trajectories may then be evaluated at block 708 to calculate their associated costs. Once all the cost of each of the trajectories are determined at block 708, they may be sorted based on their cost. At block 706 checks may be performed to determine if there are remaining trajectories, and if there are any, collision checking may be performed in 709 on the lowest cost trajectory. In some embodiments, collision checking may be based simulating the ego vehicle and surrounding vehicles and detect if their future trajectories may coincide or effectively coincide at any point. In some embodiments, collision checking may require heavy computing resources and computing time, it may be beneficial to perform collision checking on a limited number of trajectories. In this exemplary illustration, collision checking may be performed on the trajectory with the lowest cost, as shown in 709. If the trajectory passes the collision check, it may be determined to be the optimal plan at block 710. In the case that block 705 detects a potential or likely collision with the trajectory being tested, the trajectory may be dropped at block 704 and the trajectory with the next lowest cost may be tested at block 709. In some embodiments, when there are no remaining trajectories to check, as may be detected at block 706, the motion planner may encounter a situation in which it fails to find a feasible plan. In such a situation, a failure handing block 707 may intervene. It may, for example, request the human operator to control the vehicle, or it may switch to an evasive motion planner to create evasive motion to mitigate the risk of potential accidents. As used herein, the term “path” refers to a continuous curve or sequence of waypoints, defined as specific geographic locations or predefined points in space, that connects the initial state to the goal state. As used herein, the term “trajectory” refers to a time-parameterized representation of the path of the vehicle including any accompanying Z-motions. A trajectory may specify a vehicle's path, including any Z-motions, as well as, for example, details about the state of the vehicle such as speed, acceleration, steering angles, suspension dynamics, etc. As used herein, the term “motion plan” refers to a planned sequence of one or more paths selected by an operator of a vehicle.

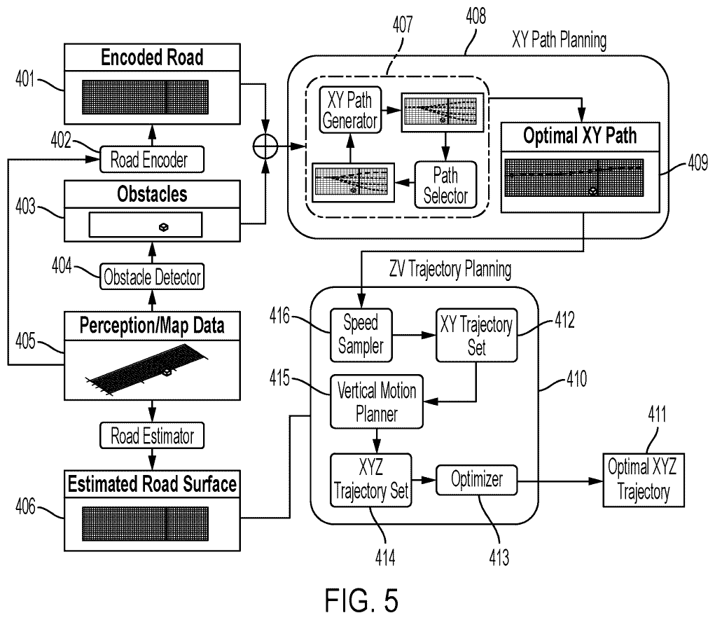

Another exemplary embodiment of a sample-based multi-stage implementation is illustrated in the block diagram in FIG. 5. The road surface data and perception of the environment of an ego vehicle may be received at block 405, for example, from a map or database, which may contain previously obtained preview information of the road surface, or from a perception software module and sensors such as LiDAR, camera, and/or rangefinder. A scan of the road surface may be performed at module 402 to detect road imperfections or anomalies that larger than a specified threshold size, such as, for example, bumps and potholes. Such imperfections or anomalies may be labeled as soft obstacles in a representation of the encoded road at module 401. The software module 408 is a path planner that optimizes the XY-path to avoid hard obstacles encoded at module 403 while trying to go around soft obstacles encoded at module 401, if possible. As used herein, the term an XY-path refers to a path in the plane of the road surface. In some embodiments, the processes in module 407, which may be applied to a moving window along the longitudinal direction of the road, and create sample paths. Subsequently the optimal one that effectively avoids obstacles may be selected. Then, the process may continue with a new window of data. The output of 408 may be the optimal XY-path as shown in 409. With this path, the software module 410 may plan an optimal Z-motion, as well as its speed profile. One implementation of 410 may be to use a speed sampler 416 to generate multiple speed profiles for the optimal XY-path 409. To create the speed profiles, a number of possible terminal speeds may be selected. Each of these terminal speeds may be blended into the current vehicle speed. With the optimal XY-path and sampled speed profiles, a set of XY-trajectories 412 may be created. Then, a vertical motion planner 415 may compute the optimal Z motion for each trajectory in the XY-trajectory set 412. As a result, an XYZ-trajectory set 415 may be created. Finally, the optimal trajectory 411 may be selected based on its cost. The selection process at module 413 may also contain collision checking and safety checking as described in connection with the method illustrated in FIG. 8. As used herein, the term “ego vehicle” refers to a vehicle that is equipped with motion planning technology and is configured to navigate and interact with its environment. It may use a variety of sensors, and other appropriate technologies, such as mapping and localization, to perceive its environment. As used herein, the term “perception software module” refers to one or more algorithms configured to process sensor data, such as data collected from accelerometers, a camera, LiDAR, and radar inputs, to characterize and/or interpret the vehicle's surrounding environment. As used herein, the term “soft obstacle” refers to an obstacle that the wheel of a vehicle may traverse by, for example, going through it or over it with at least some adverse effects but without disabling the vehicle. Soft obstacles may include obstacles such as a pothole, a manhole cover, a speed bump, broken pavement, a crack in the surface of a road, and a frost heave, a patch of rough road, or a road covered in gravel.

It should be noted that, compared with FIG. 8, the embodiment outlined in FIG. 5 may be more computationally efficient but does constrain the available solution space for motion planning. It may be a more appropriate for implementation in vehicles with more limited computing capacity, albeit at the trade-off of achieving a possibly slightly less optimal performance.

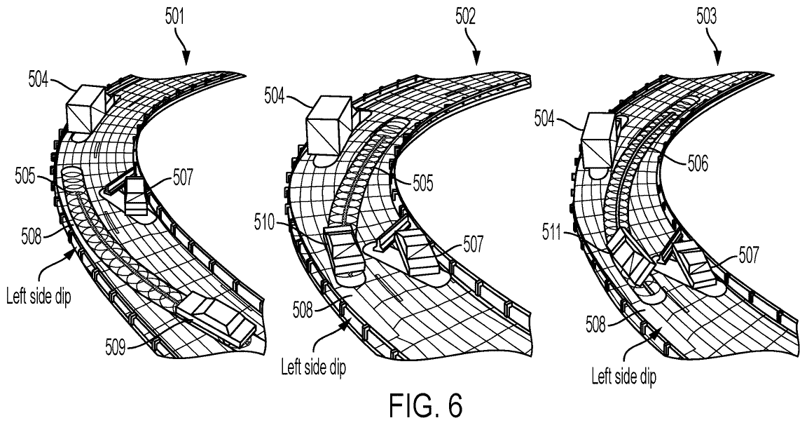

FIG. 6 illustrates an example of the safety benefits of XYZ motion planning. In driving scenario 501, the autonomous vehicle 509 equipped with an active suspension system is traveling in the right lane. The road ahead of vehicle 509 curves to the right. There are statical obstacles 507 blocking the current lane of the ego vehicle. As a result, the ego vehicle may create an XYZ motion plan 505 for a lane change to the left lane. Once the vehicle moves to the left lane, it may determine that there is a slowly moving truck 504 and that another lane change to change back to the right lane may be necessary. In the scenario illustrated in FIG. 6, there is insufficient time to slow down. Staying in the left lane may result in an accident between vehicle 509 and truck 504. It should be noted that a large road surface depression 508 is present on the left side of the left lane. The XYZ plans created by the ego vehicle may consider the road surface data and may have created plans to accordingly lower the center of gravity of vehicle body to avoid rollover caused by large lateral acceleration when traversing the depression. In scenario 502, the ego vehicle 510 has executed the XYZ plan and successfully traversed the road surface depression. Alternatively, in scene 503, when only XY plan 506 was used, the vehicle may have failed to lower its center of gravity near the road surface depression. As a result of this failure, the ego vehicle 511 may have been at a higher risk of roll-over when traversing the road surface depression.

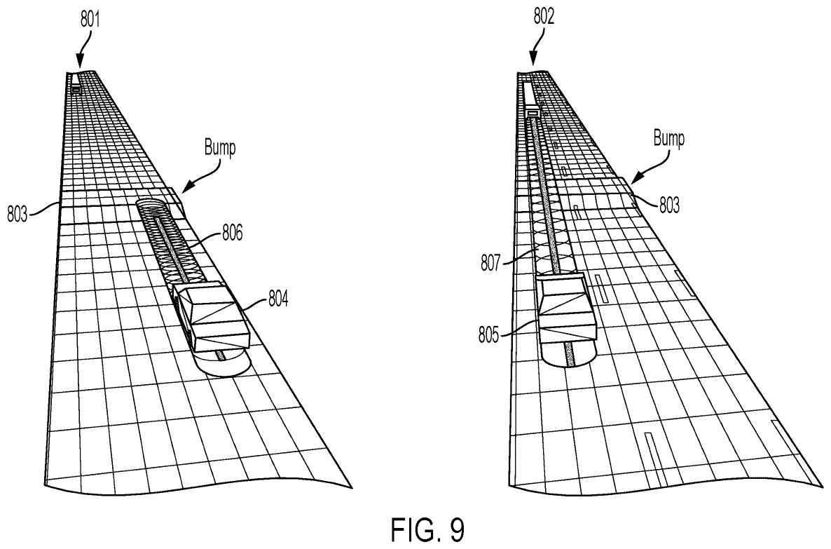

FIG. 9 illustrates another example of the safety benefits of XYZ motion planning. In both scenarios 801 and 802, the same bump 803 is present on the same road. In scenario 801, the ego vehicle 804 has an XYZ motion planner that is aware of the bump 803 in the road surface. Since the speed bump spans the entire width of the road, the motion planner may create a plan 806 that did not change the lateral displacement of the vehicle (e.g. a lane change) but slowed the vehicle down such that the active suspension system would be able to provide enough active force to lift the wheels and maintain the steady vertical position of the vehicle body when going over the bump 803. In scenario 802, the ego vehicle 804 was only equipped with an XY motion planner and it might not be able to consider various trajectories when traversing the bump 803, since there was no feasible plan to avoid the obstacle. As a result, it may ignore the presence of the bump 803 and implemented trajectory 807 that did not slow down. This may cause a larger or more intense impact at the speed bump, making the ride uncomfortable and possibly damaging the vehicle.

A vehicle may move in the in the direction of travel X in the plane of the road, laterally in the Y direction, and normal to the plane of the road in the Z direction. Controls governing the vehicle's functions in the X direction may include brakes to slow the down the vehicle and propulsion systems such as engines and motors to accelerate the vehicle. Other devices, which may affect the speed of the vehicle, may include, for example, friction devices, aerodynamic devices, or drag devices. Controls governing the vehicle's functions in Y direction may include steering systems on the front axle, rear axle, or individual wheels, as well as aerodynamic or inertial devices able to create lateral force on the vehicle or the wheels and may include braking systems able to control the yaw of the vehicle through strategic application of brake forces. Controls governing the vehicle's motion in Z direction may include active suspension systems; semi-active suspension systems; active and semi-active roll control systems; inertial devices; aerodynamic devices; suspension spring modification devices including air springs, spring seat adjustment devices, multi-chamber air springs, or mechanical devices modifying spring stiffness.

It should be noted that in the context of this disclosure, road surface characteristics are defined to include road profiles, possibly for a left and right wheel track, or for a single track, or for the entire road surface as a 3-dimensional map; road events such as individual sections of road exhibiting a shape, contour, content, or layout that meets certain characteristics, such as for example potholes, speed bumps, sections of rough road, sections of smooth road, banked roads, etc.; road surface changes including surface grip or friction, surface make-up or material type, surface roughness, or surface covering including standing water, ice, leaves, gravel, snow or other.

As used herein, term “cost function” refers to a function that associates a measure of undesirability with a potential trajectory or path. A cost function may consider factors, such as for example: safety of a vehicle and/or its occupants; collision avoidance with other vehicles, pedestrians, and/or obstacles; energy consumption; travel time; occupant comfort; violation of traffic regulations; the wear and tear of specific components, or environmental impact For example, a cost for a specific potential path a vehicle may take may include one or more discomfort metrics relating to how noticeable road events in the path may be to an occupant, and how much motion sickness such a path may cause. Cost may include a function related to how safe the vehicle will be while undertaking this path, for example considering surrounding traffic, road slope and the vehicle's propensity for a rollover, road friction and the vehicle's propensity to reach its road grip limits, propensity to startle the operator if a human operator is involved, or propensity to confuse the computing system if such a system is involved. Cost may, for example, include a function relating to the expected energy consumption for a specific path, which may be particularly relevant in electric vehicles as it will reduce travel range. Energy consumption may be affected by one or more components of the vehicle such as any motors, pumps, or friction elements involved in executing upon a desired path. Cost may also include a function related to the expected wear and tear on components or the vehicle, including for example tire wear, shock absorber wear, or motor wear, whereby for example it may be preferrable to induce less wear on components if all other elements considered for the cost function are equal.

The XYZ motion planning methods disclosed above are not only limited to autonomous vehicles. It may also be integrated into speed control features such as adaptive cruise control (ACC), and steering control features, such as lane centering control (LCC). In addition, the motion plan may be used in an advisory system for a human operator to, for example, to steer in a particular direction, and/or to speed up or slow down.

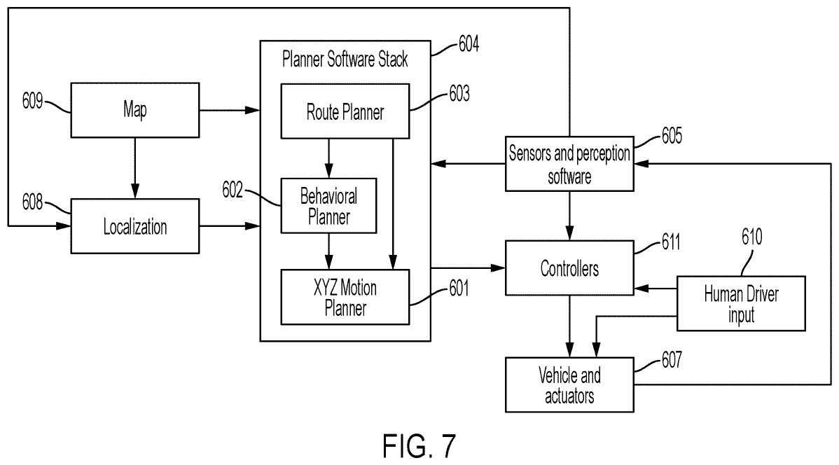

An embodiment of a system architecture of a vehicle control system which may include an XYZ motion planner is illustrated in FIG. 7. The planner software stack 604 may contain three layers: the route planner 603, which determines the optimal route from point A to point B, may take into account the overall characteristics of the entirety of multiple route options, such as, for example, the average roughness and/or representative surface friction of each route being considered in the optimization process. Note that the route optimization problem may not consider the dynamics of the vehicle. Instead, it may assign a weight based on the overall, average, or representative road surface condition of each road segment in each route being considered. The optimal solution may be the route with the minimum total composite weight of all the road segments that are considered. The route planning may occur at or before the beginning of a trip when an operator, occupant, or localization system of a vehicle may determine the starting point and operator, or occupant may determine the destination of the entire route. The system may also perform a replan of the route if the vehicle deviates too far away from a pre-planned route. Once the route is determined, a behavioral planner 602 may operate intermittently, continuously, or effectively continuously (for example, at approximately 5 Hz) to make high level decisions, such as deciding a lane change, or turn on a specific control strategy to mitigate the performance of the vehicle going over a pothole. These types of decisions may be made in the vehicle during travel because they may depend on the current state of the vehicle and its surroundings, which may be derived from sensor 605 processed by a perception software module. The third layer in the planning software is the XYZ motion planner 601, which generates a continuous or time-discrete trajectory describing the optimal vehicle state and control inputs for the next planning horizon (for example, from the current time of planning to the next 5 seconds). For fully autonomous vehicles, human operator input 610 may not be necessary, as the motion plan calculated by the motion planner 601 may be executed by the controllers 611. For example, throttle and brake command may be calculated based on a proportional-integral (PI) controller to track the reference speed profile by comparing the reference speed and the actual vehicle speed reported by the sensors 605. The XY path may be tracked by calculating the steering wheel control input, using, for example, the pure-pursuit algorithm. The reference vertical motion may be tracked by computing the appropriate force command to the active suspension system. The force command may be a combination of a feedforward control signal and a feedback control signal. The feedforward control signal may be determined based on the planned force command in the motion plan, and the feedback control signal may be determined based on the instantaneous vehicle sensor data, using, for example, a skyhook control algorithm. The control signals calculated in 611 may then be sent to the actuators in vehicle 607. For vehicles that are not fully automated or if the human operator is allowed or required to operate, the human operator can override or provide additional inputs to the controllers 611 and the actuators 607. For example, the human operator may set a different reference speed to replace the one from the plan. Also, the human operator can directly turn the steering wheel to change the driven path of the vehicle. In the case that the human operator may take full control of the vehicle, the motion plan may not be automatically executed by a controller. The calculated motion plan may be provided as recommendations or alerts to the operator. For example, while displaying the current vehicle speed to the operator, the on-board system may also show the operator what is the currently recommended optimal speed. In addition, a heads-up display system may be used in the vehicle to show the operator the recommended driving path and the estimate future path of the vehicle if it maintains the current speed and steering. As a result of this guidance, comfort and safety may be improved. Notice that the human operators would typically have no direct control to the actuators on the Z-motion, and it would typically be controlled by feedback and feed forward controllers. As used herein, the term “route” refers to a selection of consecutive road segments that may be used as an input to a motion planner or behavior planner.

To make feasible plans, the planner software stack 604 may need to determine the current location of the vehicle, with the help of a localization module 608. Also, the planner software stack 608 may also rely on a map or a database to provide information for planning purposes. In particular, the XYZ motion planner 601 may use the road surface data, which may be provided by the data stored in map 609, from the perception module 605, and/or from a database.

It should be noted that in this disclosure, a “route plan” refers to a plan with a duration of several minutes or longer (e.g., 5 minutes or longer). Conversely, a “motion plan” or “feasible motion plan” is designed to be implemented over a shorter period (e.g., less than 5 minutes or 1 minute or less). As used herein, a “short term motion plan” is a motion plan that may be implemented immediately and may have a duration of one minute or less after it is implemented.

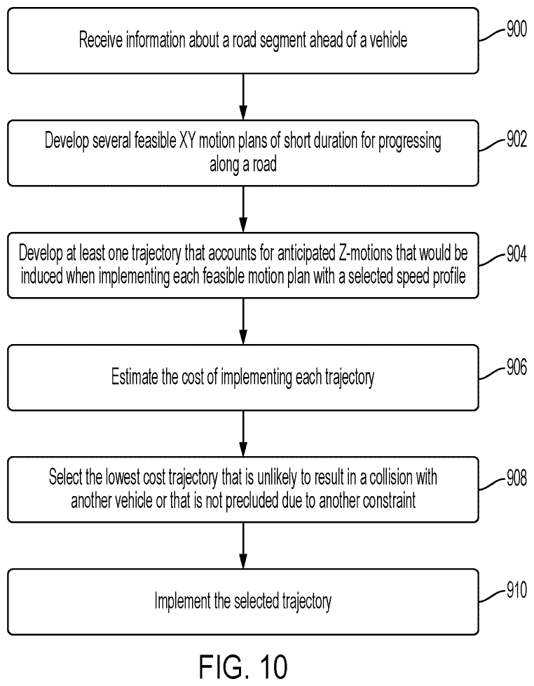

FIG. 10 is a flow chart of another embodiment of a method for operating a vehicle. In block 900, information about the road ahead is received at a processor in the vehicle. For example this information may be received from a remote or onboard database or from forward looking sensors. In block 902 several feasible in-plane XY motion plans are developed for moving forward along the road. These plans may be short term plans (for example, plans may be less than 2 minutes in duration). In block 904, a trajectory may be developed for each of the feasible XY motion plans that accounts for the anticipated Z-motions that would be induced, in at least a portion of the vehicle, by road surface irregularities, if a given plan was implemented. It should be noted that multiple trajectories could be developed for each feasible XY motion plans based on using different projected vehicle speed profile. It's worth noting that different speed profiles of the vehicle may lead to significantly different Z-motions on the same road surface. Block 906 involves estimating the cost associated with implementing each trajectory. In block 908, the lowest cost trajectory may be selected if it is unlikely to result in a collision (e.g. at higher than a threshold probability level) and adheres to one or more operational constraints. In block 910, the selected trajectory is implemented by the vehicle operator, which may be a person or an electronic controller. It is noted that each trajectory developed in block 904 may be checked for the likelihood of a collision. However, due to the computational intensity of collision detection, it may be more efficient to perform this check on the reduced set of lowest-cost trajectories.

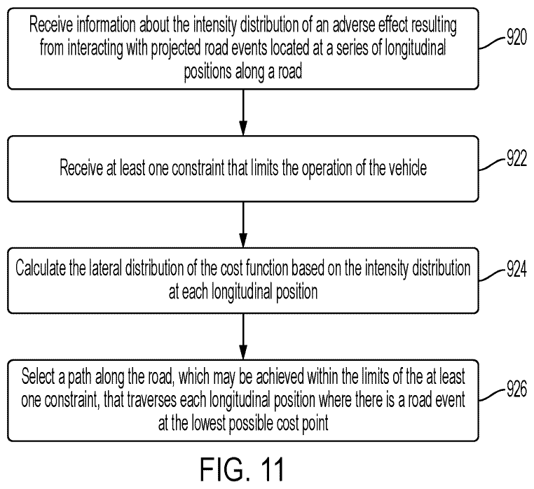

FIG. 11 is a flow chart of yet another embodiment of a method for operating a vehicle. In block 920, the system gathers information about the projected intensity distribution of potential adverse effects that could occur when the vehicle encounters road events at specific longitudinal positions along the road. This information is based on data previously collected (e.g. crowd sourced) from various vehicles that experienced these road events at different lateral offsets. In block 922 one or more operational constraints, which may impact the vehicle's actions, are received at a processor in the vehicle. In block 924, a cost function is used to determine the cost associated with traveling through each of the longitudinal positions. This calculation considers the lateral offset at which the traversal takes place. In block 926, a path is selected that may be followed while adhering to the received constraints and minimizes the total cost of traveling through the series of longitudinal positions. This method involves using data from various vehicles to predict potential adverse effects and then utilizes a cost-based approach to choose the best path for the vehicle, while taking into account operational constraints.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of operating a vehicle, the method comprising:
traveling along a road;
receiving information about a segment of the road ahead of the vehicle, wherein the information includes data about a surface of the road ahead of a current position of the vehicle;
based on the received information, using an algorithm to develop a multiplicity of feasible motion plans for moving forward from the current position of the vehicle;
developing one or more trajectories for each of the multiplicity of feasible motion plans, wherein at least one of the one or more trajectories accounts for out of plane motions induced by one or more anomalies in the road surface;
projecting a cost of traveling along each of the one or more trajectories for each of the multiplicity of feasible motion plans;
selecting a trajectory based at least partially on cost;
providing the selected trajectory to a vehicle operator; and
operating the vehicle by implementing the selected trajectory.

2. The method of claim 1, wherein the vehicle operator is selected from the group consisting of a computing device and a person.

3. The method of claim 1, wherein at least a portion of the received data is received from a database that includes previously collected information about the road.

4. The method of claim 1, wherein at least a portion of the received data is received from a look-ahead sensor on-board the vehicle.

5. The method of claim 1, wherein the vehicle is a semi-autonomous vehicle.

6. The method of claim 1, wherein the data about the surface of the road includes data about road surface anomalies selected from the group consisting of a pothole, a speed bump, a road surface crack, a manhole cover, and a storm grate.

7. The method of claim 1, wherein projecting the cost is based on a factor selected from the group consisting of energy consumption; travel time, occupant comfort, violation of traffic regulations, wear and tear of components, safety and environmental impact.

8. The method of claim 1, wherein the multiplicity of feasible motion plans does not include a plan where a probability of collision with another vehicle is greater than a threshold value.

9. The method of claim 1, wherein the multiplicity of feasible motion plans does not include a plan where a probability of collision with an obstacle.

10. A method of operating a vehicle the method comprising:
traveling along a road;
receiving information about a segment of the road ahead of the vehicle, wherein the information includes data about a surface of the road ahead of a current position of the vehicle;
based on the received information, using an algorithm to develop a multiplicity of feasible motion plans for moving forward from the current position of the vehicle;
developing one or more trajectories for each of the multiplicity of feasible motion plans, wherein at least one of the one or more trajectories accounts for out of plane motions induced by the road surface;
projecting a cost for traveling along each of the one or more trajectories for each of the multiplicity of feasible motion plans;
determining a probability of collision, with another vehicle, when implementing a lowest cost trajectory, is greater than a threshold value; and
operating the vehicle by implementing a trajectory with a next lowest cost trajectory where the probability of collision is lower than the threshold value.

11. The method of claim 10, wherein the vehicle operator is selected from the group consisting of a computing device and a person.

12. The method of claim 9, wherein at least a portion of the received data is received from a database that includes previously collected information about the road.

13. The method of claim 9, wherein at least a portion of the received data is received from a look-ahead sensor on-board the vehicle.

14. The method of claim 9, wherein the vehicle is a semi-autonomous vehicle.

15. The method of claim 9, wherein the data about the surface of the road includes data about road surface anomalies selected from the group consisting of a pothole, a speed bump, a road surface crack, a manhole cover, and a storm grate.

16. The method of claim 9, wherein projecting the cost is based on a factor selected from the group consisting of energy consumption; travel time, occupant comfort, violation of traffic regulations, wear and tear of components, safety and environmental impact.

17. A method of operating a vehicle, the method comprising:
traveling along a road;
receiving information about a segment of the road ahead a current position of the vehicle;
based on the received information, selecting a trajectory with a duration of less than two minutes, wherein the trajectory includes both XY motions and Z motions;
providing the trajectory to a vehicle operator; and
operating the vehicle by implementing the trajectory.

18. The method of claim 17, wherein the duration is less than one minute.

19. The method of claim 17, wherein the duration is less than thirty seconds.

20. A method of operating a vehicle, the method comprising:
traveling along a road;
receiving information about a lateral distribution of an anticipated intensity of an adverse effect on the vehicle at a series of discrete longitudinal positions of the road;
receiving at least one constraint limiting an operation of the vehicle;
calculating a cost function based on the intensity and the at least one constraint; and
traversing each of the longitudinal positions at a point determined based on the cost function.

21. The method of claim 20, wherein the at least one constraint is selected from the group consisting of prohibition from leaving a lane of travel, offset from a centerline of the lane of travel, and maximum lateral acceleration.
